(19) United States
(12) Patent Application Publication
(10) Pub. No.: US 2007/0012394 A1
(43) Pub. Date: Jan. 18, 2007

(54) Pneumatic radial tire

(75) Inventor: Yoshiki Kanehira, Hiratsuka-shi (JP)

Correspondence Address: Patrick G. Burns, Esq.;GREER, BURNS & CRAIN, LTD., Suite 2500, 300 S. Wacker Drive, Chicago, IL, 60606, US

(73) Assignee: THE YOKOHAMA RUBBER CO., LTD.

(21) Appl. No.: 11/484,414

(22) Filed: Jul. 11, 2006

(30) Foreign Application Priority Data
Jul. 13, 2005 (JP) JP2005-204657

(51) Int. Cl. B60C 9/00

(52) U.S. Cl. 152/527; 152/531

(57) ABSTRACT

Disclosed is a pneumatic tire which comprises belt layers in a tread part and belt cover layers formed by winding organic fiber cords spirally and continuously in the tire circumferential direction on outer peripheries of at least both edge portions of the belt layer respectively. The organic fiber cords are twisted cords of at least one polyketone fiber yarns having a heat shrinkage stress at 150° C. of 0.19 to 0.60 cN/dtex.

### BACKGROUND OF THE INVENTION

1. Field of the Invention

The present invention relates to a pneumatic radial tire, and more particularly relates to a pneumatic radial tire configured so as to attain both reduction of road noise and reduction of rolling resistance in a case where belt cover layers are made of polyketone fiber cords.

2. Description of the Prior Art

Road noise among noises generated by a pneumatic tire is resonance noise generated as follows. When vibration taken by the tire from road surface is transmitted through an axle to a vehicle compartment, the resonance noise is generated by the vibration resonating with the vehicle compartment. Conventionally, it is known that, as one of countermeasures for reducing road noise, there are belt cover layers formed by winding organic fiber cords spirally and continuously in the tire circumferential direction on outer peripheries of at least both edge portions of belt layers. Since the belt cover layers increase rigidity of both of the edge portions of the belt layers, road noise is reduced.

From the above-described knowledge, many attempts have been proposed to further increase the road noise reduction effects by using polyketone fiber cords, which have an elastic modulus higher than those of generally-used organic fiber cords as reinforcement cords for the belt cover layers. (See Japanese patent application Kokai publication No. 2000-142025, for example.)

However, when the belt cover layers are formed of the polyketone fiber cords having a high elastic modulus, while the road noise reduction effects are improved by increasing the rigidity of the edge portions of the belt layers, rolling resistance tends to deteriorate because a footprint shape 10 of a tread is made shorten a length in the tire circumferential direction in each of the edge portions of the tread as illustrated in FIG. 2.

### SUMMARY OF THE INVENTION

An object of the present invention is to provide a pneumatic radial tire configured so as to attain both reduction of both of road noise and reduction of rolling resistance in a case where belt cover layers is made of polyketone fiber cords.

A pneumatic radial tire of the present invention for achieving the above-described object comprises belt layers in a tread part and belt cover layers formed by winding organic fiber cords spirally and continuously in the tire circumferential direction on outer peripheries of at least both edge portions of the belt layers respectively. The organic fiber cords are twisted cords of at least one polyketone fiber yarns defined by the following formula (1), each having a heat shrinkage stress at 150° C. of 0.19 to 0.60 cN/dtex.
—(CH₂—CH₂—CO)ₙ—(R—CO—)ₘ— (1)

where n and m have a relationship expressed by 1.05≧(n+m)/n≧1.00, and R is of alkylene groups having three carbon atoms.

The pneumatic radial tire of the present invention enhances rigidity of edge portions of the belt layers to contribute to road noise reduction, because the belt cover layers are made of the polyketone fiber cords having a high elastic modulus. In addition, since the heat shrinkage stress at 150° C. of the polyketone fiber cords is at a lower level of 0.19 to 0.60 cN/dtex, it is possible to prevent a footprint length in the edge portions of the tread from being shortened by heat shrinkage caused at times of curing and post cure inflation after the curing. For this reason, rolling resistance is prevented from deteriorating.

### BRIEF DESCRIPTION OF THE DRAWINGS

FIG. 1 is a meridional cross-sectional view of a pneumatic radial tire of an embodiment of the present invention.

FIG. 2 is a plan view illustrating a shape of a footprint of a tire.

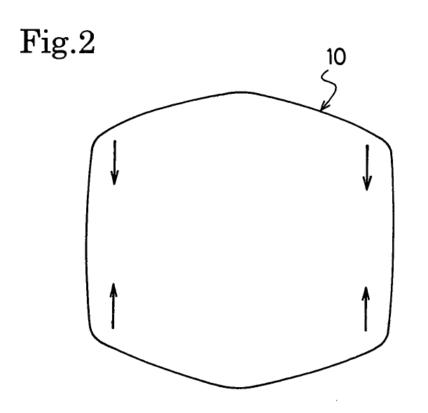

### DESCRIPTION OF THE PREFERRED EMBODIMENT

Hereinafter, detailed descriptions will be provided by referring to an embodiment of the present invention.

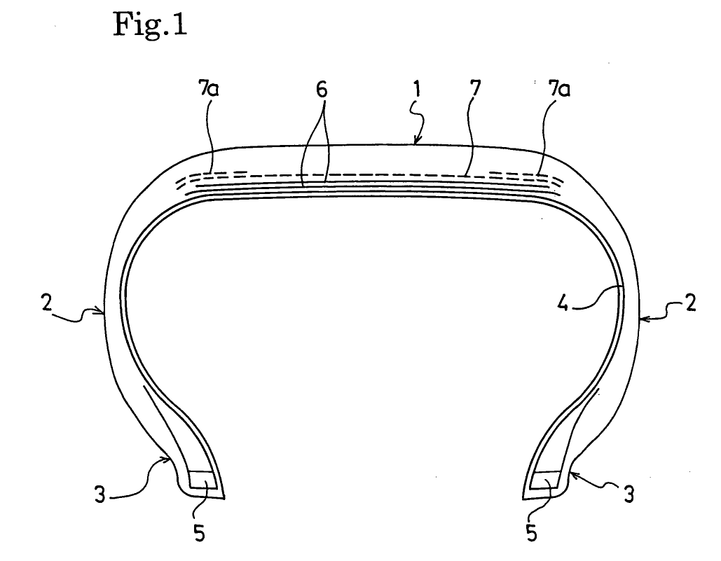

FIG. 1 illustrates a meridional cross-sectional view of a pneumatic radial tire of the embodiment of the present invention. Reference numeral 1 denotes a tread part, and reference numerals 2, 2 and 3, 3 denote respectively side wall parts and bead parts. Inside the tire, a carcass layer 4 formed of organic fiber cords is buried so as to cover all of the tread part 1, the left and right side wall parts 2, 2 and bead parts 3, 3, the organic fiber cords being arranged at an angle of approximately 90 degrees with respect to the circumferential direction of the tire. Both of the end portions of the carcass layer 4 are folded back around bead cores 5, 5 from the inside to the outside of the tire.

Two belt layers 6 formed of steel cords are provided around an outer periphery of the carcass layer 4. A belt cover layer 7 and belt cover layers 7a are provided around the belt layers 6. The belt cover layer 7 covers the entire width of the belt layers 6, and the belt cover layers 7a cover respectively only the edge portions of the belt layers 6. The belt cover layers 7 and 7a are made of twisted cords of polyketone fibers defined by the above-described formula (1). These belt cover layers are formed in a way that the twisted cords are spirally and continuously wound around the belt layers 6 at a smaller angle of 0 to 5 degrees with respect to the circumferential direction of the tire. As illustrated in FIG. 1, these belt cover layers are preferably formed of a combination of both a full cover layer 7 covering the overall width of the belt layers and edge cover layers 7a covering respectively the edge portions of the belt layers. However, either the belt cover layer 7 or belt cover layers 7a may be provided. In short, when at least both of the circumferential edge portions of the belt layers 6 are covered, the configuration thereof can contribute to road noise reduction.

In the present invention, the twisted cords formed of polyketone fiber yarns and constituting belt cover layers are set to have a low heat shrinkage stress in a range of 0.19 to 0.60 cN/dtex at 150° C. Since the value of the heat shrinkage stress is set lower as described, the twisted cords do not bite into both of the edge portions of the belt layer even when the twisted cords are heated in curing process of a tire, and tensile force thereof is maintained constant in a post cure inflation process after curing as well. Thus, the polyketone fiber cords are prevented from biting into the edge portions of the belt layers.

Accordingly, a footprint length is inhibited from being shorter in each of the end parts of the tread, whereby rolling resistance is prevented from being deteriorated. In addition, since rigidity of the edge portions of the belt layers is increased because of the twisted cords of polyketone fiber yarns having a high elastic modulus, it is also possible to improve road noise reduction effects. When polyketone fiber yarns having the heat shrinkage stress at 150° C. of lower than 0.19 cN/dtex are used, road noise reduction effects are insufficient as those obtained in the case where conventional nylon 66 fiber cords are used. When polyketone fiber yarns having the heat shrinkage stress at 150° C. of higher than 0.60 cN/dtex are used, the polyketone fiber cords bite into the edge portions of the belt layer and thus rolling resistance deteriorates.

The value of “heat shrinkage stress at 150° C.” defined in the present invention is measured in accordance with the following measuring method.

In accordance with JIS L 1017, the following measurement is performed. An end of a sample of fiber cord is grasped to be supported by an upper gripper in an oven, and an initial load F° (=total mass density of fiber (dtex)×0.45 mN) is added to the other end of the sample in order that the length of the sample is adjusted to be 250 mm. Thereafter, a force F generated in the sample is measured, while temperature of the sample is being increased by means of a pattern of temperature increase described below. Based on a measurement result, heat shrinkage stress is calculated for five times by use of the values of the force F(150° C.) generated at 150° C., using the following formula (2) described below. An average of values obtained through calculation respectively on the basis of such five measurement results is referred to as “heat shrinkage stress S(150° C.) at 150° C.”
S(150° C.)=F(150° C.)/d (2)

where, S(150° C.): heat shrinkage stress at 150° C. (cN/dtex)
F(150° C.): force generated in the sample at 150° C. (cN)
d: mass density of fiber (dtex)

(Pattern of Temperature Increase)

The temperature in the oven is increased from room temperature to 40° C. in one minute, and then is maintained at 40° C. for one minute. Subsequently, the temperature is increased to 250° C. by temperature increasing rate of 5° C. per minute.

In order to obtain polyketone fiber cords having low heat shrinkage stress as described above, a tensile force of each of the cords in the process using a bonding agent after the twisting process may be adjusted to be relatively lower. In other words, when twisted cords after twisting are processed in a way that the twisted cords are dipped in a resin solution of resorcin, formalin and latex (RFL solution), thermal process may be carried out with relatively low tensile force of each of the cords. To be specific, it is preferable that the tensile force be in a range of 0.1 to 1.32 cN/dtex and the heating temperature be in a range of 200° C. to 260° C. It is more preferable that the tensile force be in a range of 0.7 to 1.32 cN/dtex and the heating temperature be in a range of 220° C. to 240° C.

Furthermore, each of the above-described twisted cords of the polyketone fiber yarns is preferably formed in a way that at least one polyketone fiber yarns having a fineness of 500 to 1670 dtex/yarn are twisted. In other words, the twisted cord may be obtained by twisting only one polyketone fiber yarn having a fineness of 500 to 1670 dtex, or may be one obtained in a way that each of at least two polyketone fiber yarns are twisted first and thereafter the twisted fibers are put together to be twisted. When each of the polyketone fiber yarns has a fineness of smaller than 500 dtex, road noise reduction effects are reduced. On the other hand, when each of the polyketone fiber yarns has a fineness of larger than 1670 dtex, the polyketone fiber cords bite into the edge parts of the belt layers, whereby deterioration of rolling resistance is caused.

### EXAMPLE

Nine types of pneumatic radial tires having a size of 225/60R16 and a tire structure illustrated in FIG. 1 were manufactured. For each of the tires, polyketone fiber cords were used as reinforcement cords for belt cover layers. The tires were different from one another in a fineness and heat shrinkage stress as shown in Table 1.

In accordance with the following measurement methods, the nine types of pneumatic radial tires were measured with respect to road noise, rolling resistance, and whether failure due to curing is caused. The results shown in Table 1 were obtained.

[Road Noise]

Each of the tires was mounted on a rim with a rim size of 16×7JJ and was filled with air with an air pressure of 210 kPa. A sound pressure level at a time when a vehicle is driven on a paved road at a speed of 60 km/h was measured by means of a microphone attached in a position of window side of a driver's seat of the vehicle.

Evaluation was made by use of multiplicative inverses of respective measurement values. The evaluation is indicated in indices by setting the multiplicative inverse of the measurement value in Comparative Example 1 as 100. The larger an index value of a tire is, the lower a sound pressure level is and this means that the tire is excellent in road noise reduction performance.

[Rolling Resistance]

Each of the tires was mounted on a rim with a rim size of 16×7JJ, and preliminary driving was carried out for 30 minutes under conditions of air pressure defined by JATMA. Thereafter, a load of 98N is applied to the tire on an experimental drum having a diameter of 1700 mm and rolling resistance of the tire at a time when a vehicle is driven at a speed of 80 km/h was measured.

The evaluation is indicated in indices by setting the measurement value in Comparative Example 2 as 100. The smaller the index value is, the smaller the rolling resistance is.

[Failure Due to Curing]

After each of green tires was cured, the tire was cut to visually determine whether belt cover layers bit into the edge parts of belt layers.

TABLE 1

| | | Heat | | | |
|---|---|---|---|---|---|
| | | Shrinkage | | | |
| | Cord Composition | Stress at | | Rolling | Failure due to |
| | (dtex/number of | 150° C. | Road Noise | Resistance | Curing |
| | cords) | (cN/dtex) | (Index) | (Index) | (Yes/No) |
| EXAMPLE 1 | 1670/2 | 0.57 | 105 | 98 | No |
| EXAMPLE 2 | 1670/2 | 0.60 | 106 | 99 | No |
| EXAMPLE 3 | 1670/2 | 0.41 | 104 | 97 | No |
| EXAMPLE 4 | 1670/2 | 0.19 | 102 | 98 | No |
| COMPARATIVE | 1670/2 | 0.18 | 100 | 98 | No |
| EXAMPLE 1 | | | | | |
| COMPARATIVE | 1670/2 | 0.62 | 106 | 100 | Yes |
| EXAMPLE 2 | | | | | |
| EXAMPLE 5 | 1100/2 | 0.57 | 105 | 96 | No |
| EXAMPLE 6 | 1100/2 | 0.41 | 104 | 95 | No |
| EXAMPLE 7 | 550/2 | 0.41 | 103 | 94 | No |

What is claimed is:

1. A pneumatic radial tire which comprises belt layers in a tread part and belt cover layers formed by winding organic fiber cords spirally and continuously in the tire circumferential direction on outer peripheries of at least both edge portions of the belt layers respectively, wherein the organic fiber cords are twisted cords of at least one polyketone fiber yarns defined by the following formula (1), each having a heat shrinkage stress at 150° C. of 0.19 to 0.60 cN/dtex.
—(CH₂—CH₂—CO)ₙ—(R—CO—)ₘ— (1)
where n and m have a relationship expressed by 1.05≧(n+m)/n≧1.00, and R is of alkylene groups having at least three carbon atoms.

2. The pneumatic radial tire according to claim 1, wherein the organic fiber cords are the twisted cords of at least one polyketone fiber yarns having a fineness of 500 to 1670 dtex/yarn.

3. The pneumatic radial tire according to any one of claims 1 and 2, wherein the belt cover layers are formed of a combination of a full cover layer covering the entire width of the belt layer, and edge cover layers covering both edge portions of the belt layer.
